(19) United States
(12) Patent Application Publication
(10) Pub. No.: US 2017/0140465 A1
(43) Pub. Date: May 18, 2017

(54) SYSTEM AND METHODS FOR CONNECTING MARKETING INVESTMENT TO IMPACT ON BUSINESS REVENUE, MARGIN, AND CASH FLOW AND FOR CONNECTING AND VISUALIZING CORRELATED DATA SETS TO DESCRIBE A TIME-SEQUENCED CHAIN OF CAUSE AND EFFECT

(71) Applicant: Mark Ducros Stouse, Phoenix, AZ (US)

(72) Inventor: Mark Ducros Stouse, Phoenix, AZ (US)

(21) Appl. No.: 15/351,105

(22) Filed: Nov. 14, 2016

Related U.S. Application Data
(60) Provisional application No. 62/255,305, filed on Nov. 13, 2015.
(60) Provisional application No. 62/381,480, filed on Aug. 30, 2016.

(51) Int. Cl. G06Q 40/06; G06Q 30/02

(52) U.S. Cl. CPC G06Q 40/06; G06Q 30/0201

(57) ABSTRACT

An investment impact value chain connection and visualization system that connects marketing investment over time to financial impact and methods for connecting marketing investment to impact on business revenue, margin and cash flow and for connecting and visualizing correlated data sets to describe time-sequenced chains of cause and effect in the connection between marketing investment and financial impact are disclosed. The system and the methods deliver comprehensive, full scope assessment of marketing's contribution to revenue, margin, and cash flow via correlations between marketing stimuli and demand generation, deal expansion and sales velocity outcomes.

### CLAIM OF BENEFIT TO PRIOR APPLICATIONS

This application claims benefit to U.S. Provisional Patent Application 62/255,305, entitled “A Method For Connecting Marketing Investment To Impact On Business Revenue, Margin, And Cash Flow,” filed Nov. 13, 2015, and to U.S. Provisional Patent Application 62/381,480, entitled “A Method For Connecting And Visualizing Correlated Data Sets To Describe A Time-Sequenced Chain Of Cause And Effect,” filed Aug. 30, 2016. The U.S. Provisional Patent Applications 62/255,305 and 62/381,480 are incorporated herein by reference.

### BACKGROUND

Embodiments of the invention described in this specification relate generally to business investment analysis systems that organize, correlate, and visually output results of business investment, and more particularly, to methods for connecting marketing investment to financial impact on business revenue, margin, and cash flow, and visualizing time-shifted and correlated data sets to describe time-sequenced chains of cause and effect in the connection between marketing investment and financial impact.

Individuals and organizations around the world often engage in activities or plan events that are meant to impact future outcomes resulting from the activities or events. For example, many businesses invest in marketing efforts or product/service awareness campaigns, hoping to boost revenue, increase brand loyalty, raise awareness of product or service offerings, or impact other related aspects of the business. However, business leaders have no way of understanding the cash-on-cash return on their company's marketing investment across revenue, margin and cash flow metrics.

Existing devices and systems in this field are limited in scope and fail to account for the mid- and late-stage sales impact delivered by earned and shared channels.

Furthermore, many individuals and organizations wish to identify a cause and effect relationship between efforts exerted or money spent and the results of the efforts exerted or the money spent. Some cause and effect relationships are direct and unambiguous: drinking the hemlock caused the death of Socrates. On the other hand, many cause and effect relationships are more indirect, tenuous and distant: for example, whether posing uncomfortable philosophical questions for years caused the death of Socrates.

In addition, many individuals and organizations struggle to understand cause and effect, particularly when an extended period of time separates the cause from the effect. For example, many businesses invest in marketing efforts or product/service awareness campaigns, hoping to boost revenue, increase brand loyalty, raise awareness of product or service offerings, or impact other related aspects of the business. When cause and effect relationships are hard to understand, some individuals and organizations may end up budgeting incorrectly or promising more than can be delivered. This is problematic for such individuals and organizations, as well as others who may be better served when cause and effect relationships are understood as opposed to when cause and effect relationships are misunderstood or not understood at all.

Existing devices, systems, and approaches have not, to date, given individuals or organizations the ability to connect correlated data into a series of cause and effect relationships in any easy and rapid way by any individual, regardless of whether such individuals are trained in data science or not.

Therefore, what is needed is a way to deliver comprehensive, full scope assessments of marketing's contribution to revenue, margin, and cash flow via correlations between marketing stimuli and demand generation, deal expansion, and sales velocity outcomes, and a way to connect and visualize a series of cause and effect relationships in data over time.

### BRIEF DESCRIPTION

Some embodiments of the invention include a novel method for connecting marketing investment to financial impact on revenue, margin, and cash flow. In some embodiments, the method delivers a comprehensive, full scope assessment of marketing's contribution to revenue, margin, and cash flow via correlations between marketing stimuli and demand generation, deal expansion, and sales velocity outcomes.

Some embodiments include a novel method for connecting and visualizing correlated data sets to describe a time-sequenced chain of cause and effect. In some embodiments, the method includes connecting and visualizing a series of cause and effect relationships in data over time.

Some embodiments include a novel investment impact value chain connection and visualization system that connects marketing investment over time to financial impact. In some embodiments, the investment impact value chain connection and visualization system is a cloud-network based system that is accessible to client computing devices over a network. The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments.

FIG. 1 conceptually illustrates a method for connecting marketing investment to financial impact in some embodiments.

FIG. 2 conceptually illustrates a method for connecting marketing investment to financial impact over a duration of time that allows for inclusion of time-shifted data series in some embodiments.

FIG. 3 conceptually illustrates a method for connecting and visualizing correlated data sets to describe a time-sequenced chain of cause and effect in some embodiments.

FIG. 4 conceptually illustrates a user interface for connecting and visualizing correlated data sets to describe a time-sequenced chain of cause and effect in some embodiments.

FIG. 5 conceptually illustrates a selection of a first correlated pair graphical element in the user interface of FIG. 4.

FIG. 6 conceptually illustrates the first correlated pair graphical element added to a value chain work area in the user interface of FIG. 4.

FIG. 7 conceptually illustrates a selection of value chain tool that identifies a second correlated pair graphical element to connect to an effect data set of the first correlated pair graphical element added to the value chain work area in the user interface of FIG. 4.

FIG. 8 conceptually illustrates the identified second correlated pair graphical element (highlighted) with a causal data set that corresponds to the effect data set of the first correlated pair graphical element added to the value chain work area in the user interface of FIG. 4.

FIG. 9 conceptually illustrates the second correlated pair graphical element with time-shifted impact data added to the value chain work area in connection with the first correlated pair graphical element the user interface of FIG. 4.

FIG. 10 conceptually illustrates an example of several correlation pair graphical elements connected in a value chain that describes a time-sequenced chain of cause and effect from an awareness campaign expense amount to a financial impact recognized in revenue.

FIG. 11 conceptually illustrates a network architecture of a cloud-network investment impact value chain connection and visualization system that connects marketing investment over time to financial impact in some embodiments.

FIG. 12 conceptually illustrates an example of three alphanumeric visual indicators for the strength of correlation in three correlation pairs.

FIG. 13 conceptually illustrates an example of three circular bar graph visual indicators for the strength of correlation in three correlation pairs.

FIG. 14 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments include a system and a method for connecting marketing investment to impact on business revenue, margin, and cash flow. In some embodiments, the system and the method delivers a comprehensive, full scope assessment of marketing's contribution to revenue, margin, and cash flow via correlations between marketing stimuli and demand generation, deal expansion, and sales velocity outcomes.

Some embodiments include a system and a method for connecting and visualizing correlated data sets to describe a time-sequenced chain of cause and effect. In some embodiments, the system and the method includes connecting and visualizing a series of cause and effect relationships in data over time. In some embodiments, the system and the method for connecting and visualizing correlated data sets allow individuals, business leaders, and organizations to assemble correlated data sets into a reliable extended portrait of time-sequenced cause and effect analysis.

Some embodiments include an investment impact value chain connection and visualization system that connects marketing investment over time to financial impact. In some embodiments, the investment impact value chain connection and visualization system is a cloud-network based system that is accessible to client computing devices over a network, such as the Internet. In some embodiments, the cloud-network investment impact value chain connection and visualization system provides a private network service to users whose credentials are authenticated before computing device access is permitted.

In this specification, there are several descriptions of methods and processes that are implemented as software applications or computer programs which run on computing devices to perform the steps of the methods and/or processes. However, it should be noted that for the purposes of the embodiments described in this specification, the word “method” is used interchangeably with the word “process”. Processes or methods for connecting marketing investment to impact on business revenue, margin, and cash flow are described, therefore, by reference to example methods that conceptually illustrate steps of methods for connecting marketing investment to impact on business revenue, margin, and cash flow. Also, processes or methods for connecting and visualizing correlated data sets to describe a time-sequenced chain of cause and effect are described, therefore, by reference to an example method that conceptually illustrates steps of a method for connecting and visualizing correlated data sets to describe a time-sequenced chain of cause and effect.

As stated above, individuals and organizations often do things or spend money with a hope or an expectation of a result. Yet, so many individuals and organizations around the world struggle to understand cause and effect, especially when an extended period of time separates the cause from the effect. As such, business leaders have no way of understanding the cash-on-cash return on their company's marketing investment across revenue, margin and cash flow metrics. Embodiments of the system and methods described in this specification solve such problems by connecting and visualizing a connected chain of data sets that are correlated with respect to a cause and effect relationship of the data sets over time. Specifically, embodiments of the system and the method for connecting marketing investment to impact on business revenue, margin, and cash flow use big data analytics to connect and algorithmically correlate marketing investment to pervasive changes in audience beliefs and behaviors driven by marketing campaigns over time, and then to cash impact on revenue, margin and cash flow. Furthermore, embodiments of the system and the method for connecting and visualizing correlated data sets allow individuals, business leaders, and organizations to assemble correlated data sets into a reliable extended portrait of time-sequenced cause and effect analysis.

The embodiments described in this specification differ from and improve upon currently existing options. In particular, some embodiments of the system and the method for connecting marketing investment to impact on business revenue, margin, and cash flow differ because the common approach is to optimize marketing expense against marketing deliverables. There is no connection to business impact in a financial sense. However, the system and the method for connecting marketing investment to impact on business revenue, margin, and cash flow remedies this problem by delivering end-to-end understanding concerning marketing performance, cost-effectiveness and efficiency, and ultimate cash-on-cash return on investment (“ROI”).

Similarly, some embodiments of the system and the method for connecting and visualizing correlated data sets allow individuals, business leaders, and organizations to assemble correlated data sets into a reliable extended portrait of time-sequenced cause and effect analysis. In contrast, none of the existing options include identifiable, citable approaches to creating and visualizing multi-factor cause and effect relationships over extended periods of elapsed time, which the system and the method for connecting and visualizing correlated data sets allows users to do.

Furthermore, the currently existing options typically focus on paid marketing assets, such as advertising and trade shows, in light of the performance of owned assets (e.g., website, etc.). This is a common approach typically used by the existing options. However, this common approach is limited, accounting for perhaps thirty percent of the overall sales process and/or customer decision process but failing to account for mid- and late-stage interactions involving earned and shared marketing channels. In contrast, embodiments of the system and the method for connecting marketing investment to impact on business revenue, margin, and cash flow improve upon the common approach utilized by the existing options by accounting for marketing's impact on the full sales cycle in ways that are not currently offered by any other process, system, or practice.

In addition, the existing options typically deliver a very siloed and limited view of marketing's business impact, and generally fail to deliver the business impact metrics desired by business leaders. In contrast, embodiments of the system and the method for connecting marketing investment to impact on business revenue, margin, and cash flow deliver a comprehensive, full scope assessment of marketing's contribution to revenue, margin, and cash flow via correlations between marketing stimuli and demand generation, deal expansion, and sales velocity outcomes.

Similarly, embodiments of the system and the method for connecting and visualizing correlated data sets improve upon the currently existing options by providing a very intuitive, fast, and accurate way to connect and visualize a series of cause and effect relationships in data over time.

Several more detailed embodiments are described in the sections below. Section I describes methods for connecting marketing investment to impact on business revenue, margin, and cash flow. Section II describes a method for connecting and visualizing correlated data sets to describe a time-sequenced chain of cause and effect and provides several example user interfaces that demonstrate how the method enables a user to connect and visualize correlated data sets to describe a time-sequenced chain of cause and effect. Section III describes an investment impact value chain connection and visualization system and provides some examples of correlation strength visualization. Section IV describes an electronic system that implements one or more of the methods and generates one or more of the user interfaces.

### I. Connecting Marketing Investment to Financial Impact

The system and the method for connecting marketing investment to impact on business revenue, margin, and cash flow of the present disclosure may be broadly comprised of the following stages. This list of possible constituent stages is intended to be exemplary only and it is not intended that this list be used to limit the system or the method for connecting marketing investment to impact on business revenue, margin, and cash flow of the present application to just these stages. Persons having ordinary skill in the art relevant to the present disclosure may understand there to be equivalent stages that may be substituted within the present disclosure without changing the essential function or operation of the system and the method for connecting marketing investment to impact on business revenue, margin, and cash flow.

1. Marketing Expense Establishment

2. Marketing Campaign Performance Correlation

3. Audience Belief Assessment Correlation

4. Audience Behavior Assessment Correlation

5. Financial Impact Assessment Correlation

The various phases of the system and the method for connecting marketing investment to impact on business revenue, margin, and cash flow of the present disclosure may be related in the following exemplary fashion. It is not intended to limit the scope or nature of the relationships between the various stages and the following examples are presented as illustrative examples only. Stage #1 establishes the marketing budgets to be spent on the acquisition of revenue, margin expansion, and cash flow improvement. Stage #1 is then correlated algorithmically to stage #2, which is a detailed assessment of Marketing Campaign Performance using generally accepted industry metrics and perspectives to score the campaign's success or lack of success. Stage #2 is then correlated over time with stage #3, which is the Audience Belief Assessment Correlation stage. Stage #3 includes assessment of independent market and audience data to determine whether market and audience beliefs, including expressions of awareness, confidence, and trust, about a topic or company have changed pervasively enough to be relevant. Stage #3 is then correlated over time with stage #4, the Audience Behavior Assessment Correlation. Stage #4 includes assessment of changes to observable behavior by the market or audience as expressed in greater demand, greater deal expansion, and faster deal velocity, and as tracked in a sales database or CRM tool. Stage #4 is then correlated to stage #5, the Financial Impact Assessment Correlation stage. At stage #5, the Financial Impact Assessment Correlation identifies and represents changes to revenue, margin, and cash flow as recorded by the company.

To make the method for connecting marketing investment to impact on business revenue, margin, and cash flow of the present disclosure, a person may write the software application code to functionally and scalably carry out the steps of the method for connecting marketing investment to impact on business revenue, margin, and cash flow.

Then the software could be instantiated and run on a processing unit of a computing device to carry out the steps of the method for connecting marketing investment to impact on business revenue, margin, and cash flow. The person may also add components such as a database, a correlation engine, and a user interface so that when the software is instantiated, the steps would be performed in connection with the database, the correlation engine, and the user interface to gather, correlate and display the outcomes. Specifically, the database may gather the relevant market and audience data, as well as marketing, sales, communications and financial performance data. The correlation engine would use proprietary algorithms to assess the correlative relationship that exists or does not exist between the items, and the proprietary user interface would display those results in an attractive, customizable and easily consumable format.

Whatever the programming language or tools used to write the software, and whatever the database systems and tools used to implement a correlation engine, the method for connecting marketing investment to impact on business revenue, margin, and cash flow is able to deliver an accurate, high fidelity indication of marketing and communication's cash-on-cash contribution to business financial performance. Also, the sequencing in the method for connecting marketing investment to impact on business revenue, margin, and cash flow may include one or more optimization features, aspects, or strategies, such that other additions may negatively impact or complicate the assessment and/or introduce errors or unnecessary complexity.

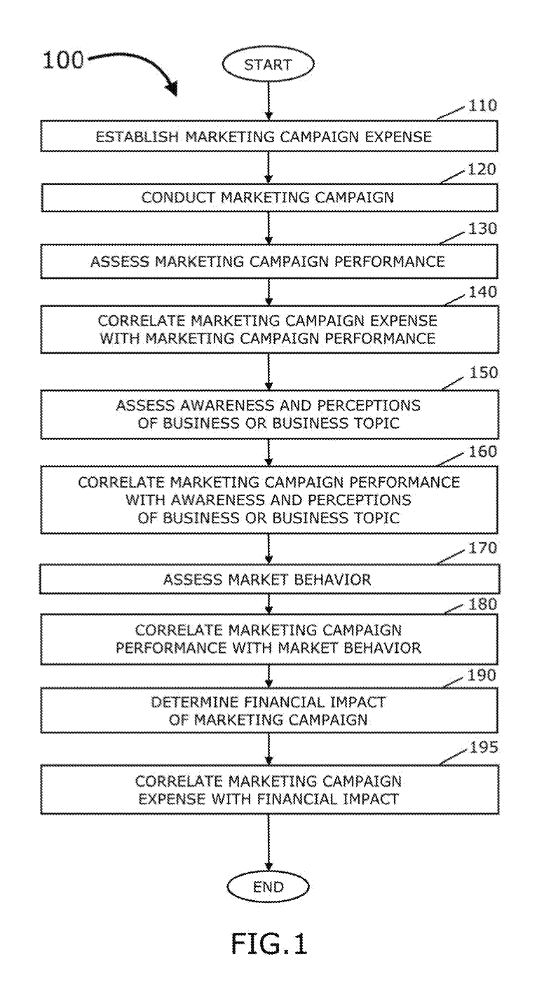

By way of example, FIG. 1 conceptually illustrates a method for connecting marketing investment to financial impact 100. The method for connecting marketing investment to financial impact 100 may be implemented as a software application in which coded instructions of the software are processed by a computing device running the software application. When the software application is instantiated, the steps of the method for connecting marketing investment to financial impact 100 are carried out by a processor of the computing device at run-time. In some deployments of the software application, additional elements or components are employed by the software application, including a database, a correlation engine, and/or an interface to process and generate a “daisy chain” of data-based cause and effect relationships automatically for the benefit of someone with ordinary skill in business management, sales, marketing or communications to use and derive rapid value from the method for connecting marketing investment to financial impact on at least business revenue, margin, and cash flow.

The method for connecting marketing investment to financial impact 100 starts when a business, organization, or other entity (hereinafter referred to as “business”) establishes (at 110) marketing campaign expense in relation to a planned marketing campaign. The operations for establishing marketing campaign expense relate to stage #1, described above, and may include any of several well-known ways to establish marketing campaign expense for a marketing campaign. For example, the business may view marketing spend in relation to paid, owned, earned, and/or shared assets. Marketing expense for an owned asset, such as a website owned and operated by the business, may be determined differently from a paid asset, such as a broadcast television advertising campaign. Furthermore, the business may establish the marketing expense in relation to the business itself or a business topic, such as a product, a service, a technology brought new to the market, etc.

Next, the method for connecting marketing investment to financial impact 100 conducts (at 120) the marketing campaign. The marketing campaign can take any of several forms of delivery to address any of several marketing objectives. Some examples of marketing objectives include, without limitation, increasing awareness of the business or business topic, increasing confidence in the business or in relation to the business topic, and increasing trust of the business or in relation to the business topic. Such marketing objectives may guide the business in determining the form of the marketing campaign. For example, the business may decide to conduct a one-off marketing campaign limited to having a booth at a trade show or the business may determine that a multifaceted marketing campaign approach is needed, which may include print, television, and online advertising, product giveaways, and presence at a trade show.

The marketing objectives may also be influenced by objectives to monetize one or more marketing channels identified for the business or business topic. Such marketing channels may be identified by any of several manners, including, without limitation, the developmental stage of the marketing stage as early stage, mid-stage, or late stage. In this example, early stage monetization of marketing channels may focus on attention grab in relation to the business or business topic, new ideas or new options provided by the business or business topic, obtaining paid assets to support the business or business topic, and/or exploiting owned assets in support of the business or business topic. In contrast, mid-stage monetization of marketing channels may focus on building or reinforcing customer value, distinguishing individual products or services from portfolios of related products or service offerings, strengthening earned assets of the business, and/or enhancing shared assets in relation to the business or business topic. Marketing campaigns can also be influenced by the needs and objectives or late stage monetization of marketing channels. Such late stage monetization of marketing channels may focus on customer success stories that reinforce the value of the business or business topic, obtaining validation of the business or business topic by arbiters, authorities, and/or recognized experts, strengthening earned assets of the business, and/or enhancing shared assets in relation to the business or business topic.

In some embodiments, the method for connecting marketing investment to financial impact 100 assesses (at 130) the marketing campaign performance. This assessment may occur after completing the marketing campaign or may occur contemporaneously with an ongoing marketing campaign. The operations for assessing the marketing campaign performance include generally accepted industry metrics and perspectives to score the campaign's success or lack of success. Next, the method for connecting marketing investment to financial impact 100 correlates (at 140) marketing campaign expense with marketing campaign performance. The operations for assessing the marketing campaign performance and correlating the marketing campaign performance to the marketing campaign expense (established at step 110 of the method for connecting marketing investment to financial impact 100) relate to the Marketing Campaign Performance Correlation, at stage #2 above.

In some embodiments, the method for connecting marketing investment to financial impact 100 assesses (at 150) the awareness and perceptions of the business or business topic. Assessing the awareness and perceptions of the business or business topic involves operations such as those described above by reference to the Audience Belief Assessment Correlation stage (or Stage #3). For example, assessing awareness and perceptions may involve assessing independent market and audience data to determine whether there is market or audience awareness of the business or business topic and what the market or audience believes about the business or the business topic. Examples of independent market and audience data include, without limitation, expressions of awareness, confidence, and trust of the business or business topic. Next, the method for connecting marketing investment to financial impact 100 correlates (at 160) the marketing campaign performance with awareness and perceptions of the business or the business topic.

In some embodiments, the method for connecting marketing investment to financial impact 100 assesses (at 170) market behavior. Assessing market behavior involves operations such as those described above by reference to the Audience Behavior Assessment Correlation (Stage #4). For example, the method for connecting marketing investment to financial impact 100 may assess market behavior by identifying and assessing changes to observable behavior in the market or by the audience. Examples of observable behavior changes that are able to be identified and assessed include, without limitation, greater market or audience demand, greater deal expansion, faster deal velocity, etc. In some cases, the observability of market and audience behavior changes in relation to the business or business topic are facilitated by sales databases, customer relationship management (“CRM”) software application, programs, or tools, or other business tracking tools. Next, the method for connecting marketing investment to financial impact 100 correlates (at 180) the marketing campaign performance with market behavior in relation to the business or the business topic.

In some embodiments, the method for connecting marketing investment to financial impact 100 determines (at 190) the financial impact of the marketing campaign. In some embodiments, the financial impact of the marketing campaign is based on a sum of revenue that is directly or indirectly attributable to the marketing campaign expense. In some embodiments, the indirectly attributable revenue is based on the marketing campaign performance, awareness and perceptions of the market or audience in relation to the business or business topic, and the market behavior of the market or audience in relation to the business or business topic. In some embodiments, the financial impact of the marketing campaign is based on revenue, margin, and cash flow as expressed by demand generation, deal expansion, and sales velocity outcomes.

In some embodiments, after the financial impact is determined, the method for connecting marketing investment to financial impact 100 correlates (at 195) the marketing campaign expense (or “marketing spend”) with the determined financial impact. Then the method for connecting marketing investment to financial impact 100 ends.

The example above demonstrates how the method for connecting marketing investment to financial impact 100 delivers a comprehensive, full scope assessment of marketing's contribution to revenue, margin, and cash flow via correlations between marketing stimuli and demand generation, deal expansion, and sales velocity outcomes. In some embodiments, the method for connecting marketing investment to financial impact allows for time-delayed data related to demand generation, deal expansion, and sales velocity outcomes to be considered in the calculation of the financial impact of marketing campaign expense.

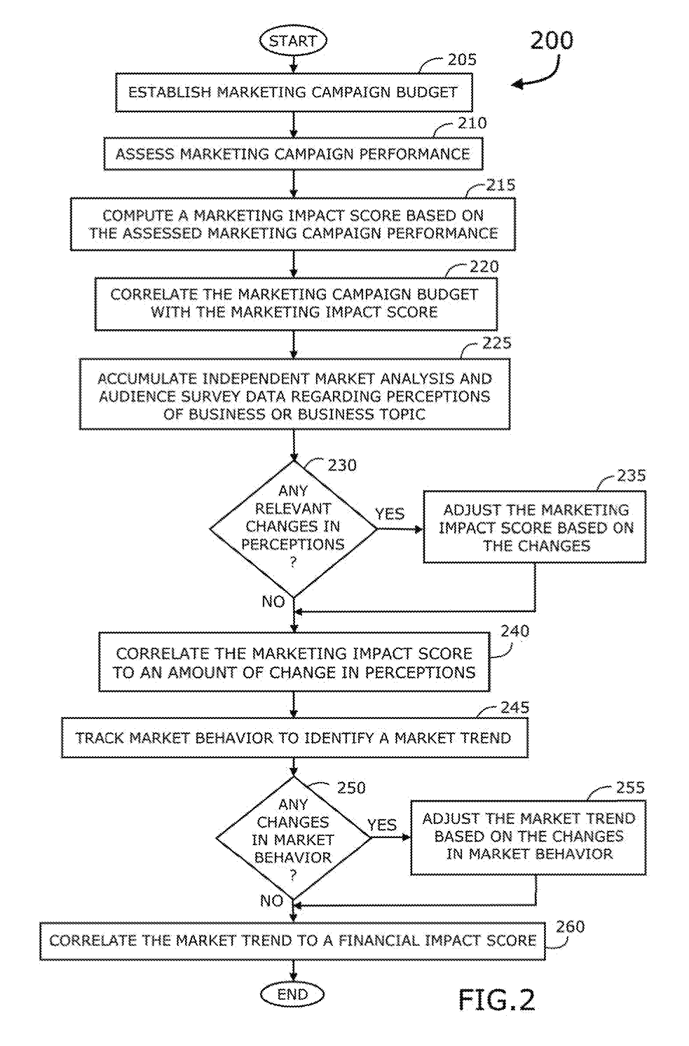

By way of example, FIG. 2 conceptually illustrates a method for connecting marketing investment to financial impact over a duration of time that allows for inclusion of time-shifted data series 200. The method for connecting marketing investment to financial impact over a duration of time that allows for inclusion of time-shifted data series 200 (hereinafter referred to as “the method for connecting marketing investment to financial impact over time 200”) may be implemented as a software application in which coded instructions of the software are processed by a computing device running the software application. When the software application is instantiated, the steps of the method for connecting marketing investment to financial impact over time 200 are carried out by a processor of the computing device at run-time. In some deployments of the software application, additional elements or components are employed by the software application, including a database, a correlation engine, and/or an interface to process and generate a “daisy chain” of data-based cause and effect relationships automatically for the benefit of someone with ordinary skill in business management, sales, marketing or communications to use and derive rapid value from the method for connecting marketing investment to financial impact over time 200 on at least business revenue, margin, and cash flow.

The method for connecting marketing investment to financial impact over time 200 starts when a business establishes (at 205) a marketing campaign budget (or marketing expense, marketing spend, etc.). Details of establishing a marketing campaign budget are described in greater detail above at step 110 of the method for connecting marketing investment to financial impact 100, described by reference of FIG. 1. Next, after the marketing campaign completes or while the marketing campaign continues, the method for connecting marketing investment to financial impact over time 200 assesses (at 210) the marketing campaign performance. Details of assessing the marketing campaign performance are described in greater detail above at step 130 of the method for connecting marketing investment to financial impact 100, described by reference of FIG. 1.

In some embodiments, the method for connecting marketing investment to financial impact over time 200 computes (at 215) a marketing impact score. The marketing impact score is computed based on the assessed marketing campaign performance. A marketing impact score is an expression of marketing campaign performance and, therefore, may change over time. The marketing impact score may be a numerical value or a non-numerical indicator of the marketing campaign performance. Examples of marketing scores that express marketing campaign performance include, without limitation, numerical values (e.g., 1 for highly successful, 2 for mildly successful, 3 for adequate, 4 for mildly unsuccessful, 5 for highly unsuccessful, etc.), alphabetical valuations (e.g., AAA for highly successful, AA for mildly successful, A for adequate, B for approaching adequate, BB for mildly unsuccessful, BBB for highly unsuccessful, etc.), binary indicators (e.g., successful or unsuccessful, pass or fail, etc.), trend indicators (e.g., marketing campaign improving, marketing campaign losing appeal, etc.), actual performance in relation to expected performance (e.g., performance exceeded expectations, performance under expectations, etc.), and so forth.

Next, the method for connecting marketing investment to financial impact over time 200 correlates (at 220) the marketing campaign budget (or marketing expense or marketing spend) with the marketing impact score.

In some embodiments, the method for connecting marketing investment to financial impact over time 200 accumulates (at 225) independent market analysis and audience survey data regarding perceptions of the business or the business topic. Details of accumulating independent market analysis and audience survey data regarding perceptions of the business or the business topic are described in greater detail above at step 150 of the method for connecting marketing investment to financial impact 100, described by reference of FIG. 1. Next, the method for connecting marketing investment to financial impact over time 200 determines (at 230) whether there are any relevant changes in perceptions. When there are no relevant changes in perceptions, the method for connecting marketing investment to financial impact over time 200 correlates (at 240) the marketing impact score to an amount of change in perceptions (i.e., no relevant changes in perceptions). On the other hand, when there are relevant changes in perceptions, the method for connecting marketing investment to financial impact over time 200 adjusts (at 235) the marketing impact score according to the changes. After adjusting the marketing impact score, the method for connecting marketing investment to financial impact over time 200 correlates (at 240) the marketing impact score to the amount of change in perceptions.

In some embodiments, the method for connecting marketing investment to financial impact over time 200 tracks (at 245) market behavior to identify a market trend. Details of tracking market behavior to identify a market trend are described above at step 170 of the method for connecting marketing investment to financial impact 100, which includes identifying and assessing changes to observable behavior in the market or by the audience, such as greater market or audience demand, greater deal expansion, faster deal velocity, etc., as described by reference of FIG. 1. Next, the method for connecting marketing investment to financial impact over time 200 determines (at 250) whether there are any changes in market behavior. When there are no changes in market behavior, the method for connecting marketing investment to financial impact over time 200 correlates (at 260) the market trend to a financial impact score. On the other hand, when there are changes in market behavior, the method for connecting marketing investment to financial impact over time 200 adjusts (at 255) the market trend based on the changes in market behavior. After adjusting the market trend, the method for connecting marketing investment to financial impact over time 200 correlates (at 260) the market trend to the financial impact score. Then the method for connecting marketing investment to financial impact over time 200 ends.

To use the method for connecting marketing investment to impact on business revenue, margin, and cash flow of the present disclosure, a person would install the software that implements the method for connecting marketing investment to impact on business revenue, margin, and cash flow. The person may then link the prescribed data sources to the software via APIs. The method, as instantiated in software, would then begin to correlate and calculate the relationships between the data sets over time. Those results would be displayed via the user interface in the software for consumption and use. The method, as instantiated in the software, runs perpetually and delivers updated outcomes on demand.

While the details and examples in this section pertain to methods for connecting marketing investment to impact on business revenue, margin, and cash flow in general and over time, the next section includes details and examples of a method for connecting and visualizing correlated data sets to describe a time-sequenced chain of cause and effect, as well as descriptions and details of several example user interfaces that demonstrate how the method enables a user to connect and visualize correlated data sets to describe a time-sequenced chain of cause and effect.

### II. Connecting and Visualizing Correlated Data Sets to Describe a Time-Sequenced Chain of Cause and Effect

The method for connecting and visualizing correlated data sets to describe a time-sequenced chain of cause and effect of the present disclosure may be comprised of the following phases of steps. This list of possible constituent phases is intended to be exemplary only and it is not intended that this list be used to limit the method for connecting and visualizing correlated data sets to describe a time-sequenced chain of cause and effect of the present application to just these phases and/or the method steps included in each phase. Persons having ordinary skill in the art relevant to the present disclosure may understand there to be equivalent phases and/or steps that may be substituted within the present disclosure without changing the essential function or operation of the method for connecting and visualizing correlated data sets to describe a time-sequenced chain of cause and effect.

1. Data Correlations (first phase)

2. Representation of Data Correlations (second phase)

3. System to Connect the Data Correlations into a Series (third phase)

The various phases and steps of the method for connecting and visualizing correlated data sets to describe a time-sequenced chain of cause and effect of the present disclosure may be related in the following exemplary fashion. It is not intended to limit the scope or nature of the relationships between the various phases and steps and the following examples are presented as illustrative examples only. The Data Correlations phase includes steps that make up a process for comparing two or more time series of data to determine whether and to what extend a correlation may exist. The Data Correlations phase includes steps that make up a process for representing and displaying the data correlations as graphical elements (e.g., graphical domino elements) for display in a graphical user interface (GUI), with the causal element on the left side or being represented as the numerator (top) and the effect element on the right side or being represented as the denominator (bottom) of that pairing, together with a representation of the correlation strength between those data sets at that time and the elapsed time between the cause and the effect. The GUI then allows a user to interact with and connect the correlation pair graphical elements together like dominoes, creating a total time-shifted chain of cause and effect spanning numerous factors and individual time shifts.

To make the method for connecting and visualizing correlated data sets to describe a time-sequenced chain of cause and effect of the present disclosure, one may implement the steps of the method as a software application with a graphical user interface (GUI) that can render domino-looking graphical elements (or “domino GUI elements”) that represent correlated pairs of data sets, and to connect domino graphical elements in a chain of at least one domino and no upper limit on the number of dominoes that may be connected together within the GUI. The ability to construct and visualize the chain of time-shifted correlations is a unique approach to the aforementioned problem.

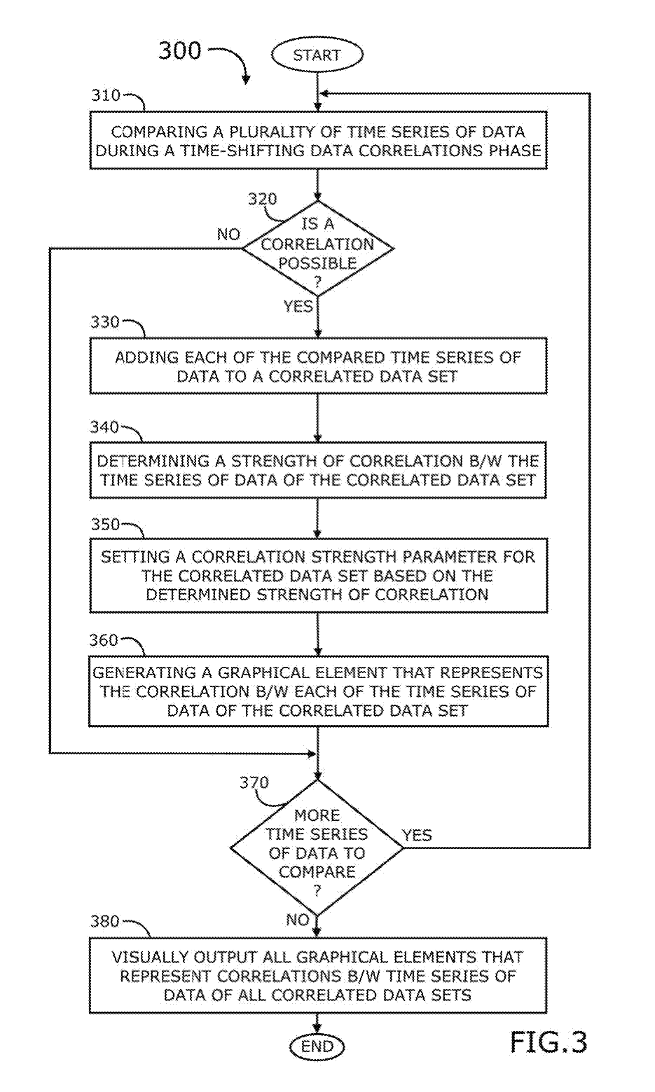

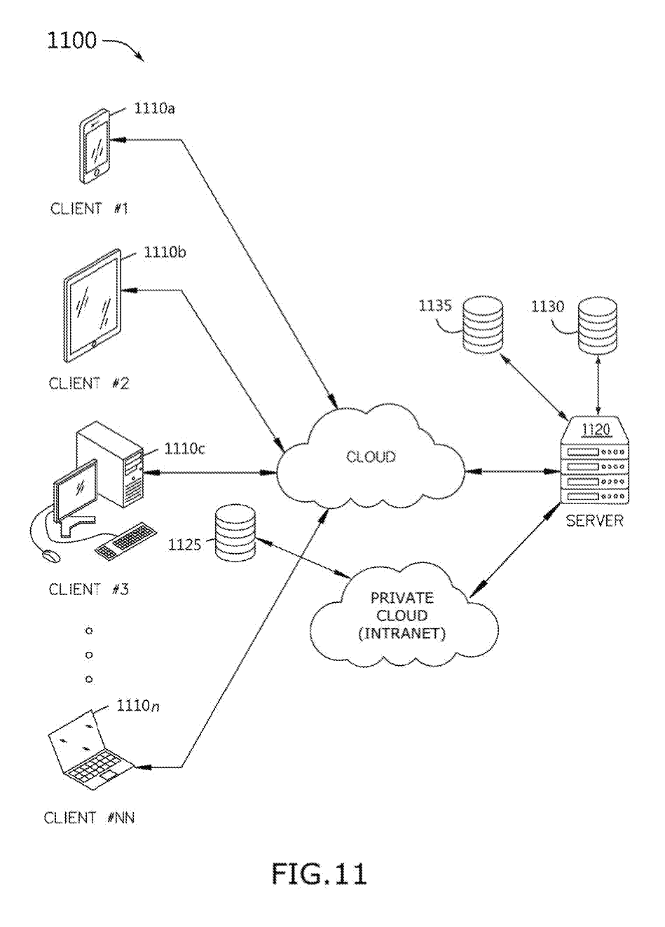

By way of example, FIG. 3 conceptually illustrates a method for connecting and visualizing correlated data sets to describe a time-sequenced chain of cause and effect 300. As noted above, the method 300 may be implemented as a software application that presents a GUI at runtime and allows a user to interact with correlated pair graphical elements (such as domino GUI elements) that represent correlated data sets. Further to this, the steps of the method 300 may be implemented by any of several programming languages, and may be built to deliver a scalable solution for connecting and visualizing correlated data sets. As such, the software application may run on a processor of a single computing device, such as a personal computer, a mobile phone, a tablet computing device, or other computing devices. Alternatively, the software application may run on a processor of a network-based server computing device that hosts an application service for user computing devices to access in order to connect and visualize correlated data sets. For example, the network-based server computing device may be a cloud-based server computing device or a private LAN-based server computing device, or any other such networked server computing device. In this way, the method for connecting and visualizing correlated data sets to describe a time-sequenced chain of cause and effect 300 is able to provide a solution that is visually intuitive and that can scale as high as needed, by deploying and running the implementing software on a network server that has a cloud-network software as a service (SaaS) architecture. An example network architecture of a cloud-network investment impact value chain connection and visualization system that connects marketing investment over time to financial impact is described below by reference to FIG. 11.

Alternatively, the method for connecting and visualizing correlated data sets to describe a time-sequenced chain of cause and effect can be deployed on a low scale system or device where one or more of a memory footprint, a network traffic footprint, and a processor utilization footprint are small. For instance, deploying and running the implementing software on a network server that has a basic two-tier client-server architecture for use in a small local area network (LAN).

In some embodiments, the method for connecting and visualizing correlated data sets to describe a time-sequenced chain of cause and effect 300 initially compares (at 310) a pair of time series of data among a plurality of time series of data. For instance, a business may have several sets of marketing campaign data that is spread over time with each set of data being a separate time series of data. The method 300 compares the pair of time series of data during the time-shifting Data Correlations phase described above. In comparing the multiple time series of data, the method 300 of some embodiments compares a single pair of time series of data and proceeds to complete subsequent steps of the method 300 before returning to compare a next pair of time series of data. When all is said and done, each particular time series of data is compared with each other time series of data in among the multiple time series of data.

Next, the method for connecting and visualizing correlated data sets to describe a time-sequenced chain of cause and effect 300 determines (at 320) whether a correlation is possible between the compared pair of time series of data. Again, this determination step is performed for any and all time series of data pairs that the method 300 compares, ensuring that all of the separate time series of data are compared to each other to identify whether correlations can be made. When a correlation is not possible for the present pair of time series of data being compared, the method for connecting and visualizing correlated data sets to describe a time-sequenced chain of cause and effect 300 transitions to 370 to determine whether more time series of data remain to be compared (described in detail below). On the other hand, when a correlation is possible for the present pair of time series of data being compared, the method for connecting and visualizing correlated data sets to describe a time-sequenced chain of cause and effect 300 adds (at 330) each of the compared time series of data to a correlated data set.

In some embodiments, the method for connecting and visualizing correlated data sets to describe a time-sequenced chain of cause and effect 300 determines (at 340) a strength of correlation between the time series of data of the correlated data set. Next, the method 300 sets (at 350) a correlation strength parameter for the correlated data set based on the determined strength of correlation.

In some embodiments, the method for connecting and visualizing correlated data sets to describe a time-sequenced chain of cause and effect 300 then generates (at 360) a correlated pair graphical element that represents the correlation between each of the time series of data of the correlated data set. In some embodiments, the method 300 adds a strength of correlation graphical element to the correlated pair graphical element. In some embodiments, the method 300 adds time information, revenue or value information, and/or other information to the strength of correlation graphical element or to the correlated pair graphical element.

Next, the method for connecting and visualizing correlated data sets to describe a time-sequenced chain of cause and effect 300 of some embodiments determines (at 370) whether more time series of data remain to be compared. When there are more time series of data that remain to be compared, the method 300 returns back to step 310 to compare another pair of time series of data, as is described in greater detail above. On the other hand, when there are no more time series of data to compare, the method visually outputs (at 380) all of the correlation pair graphical elements with any related strength of correlation graphical elements or other information. Then the method for connecting and visualizing correlated data sets to describe a time-sequenced chain of cause and effect 300 ends.

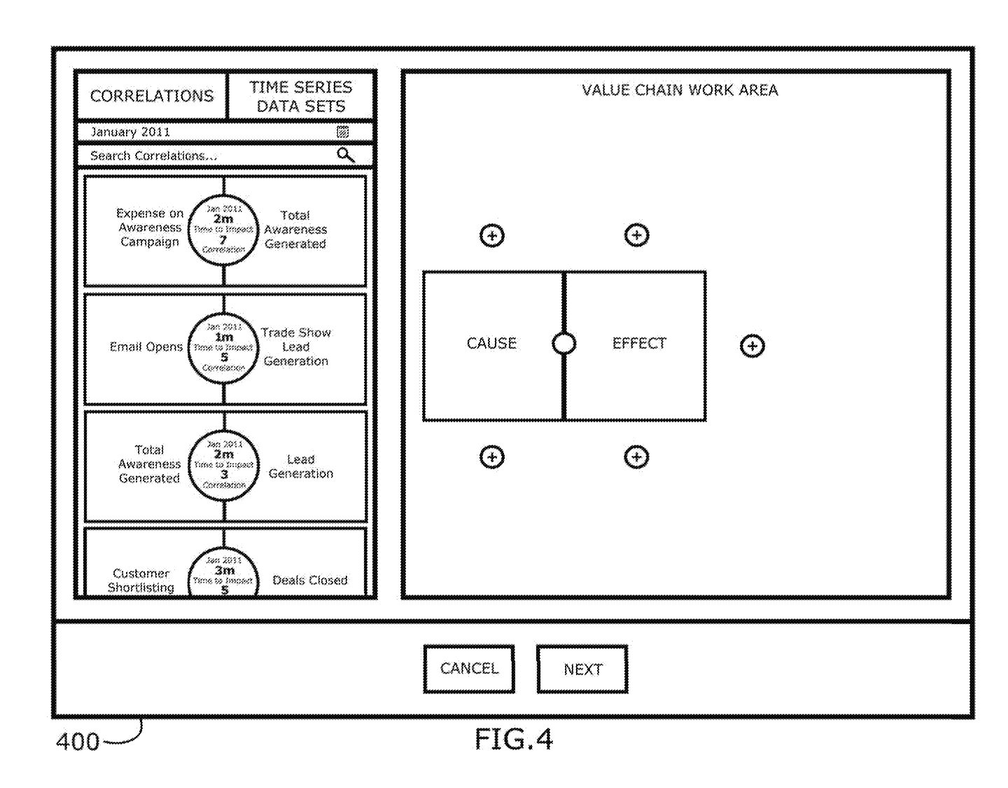

By way of example, FIGS. 4-10 conceptually illustrate example graphical user interfaces (GUIs) that facilitate a user in connecting and visualizing correlated data sets to describe a time-sequenced chain of cause and effect.

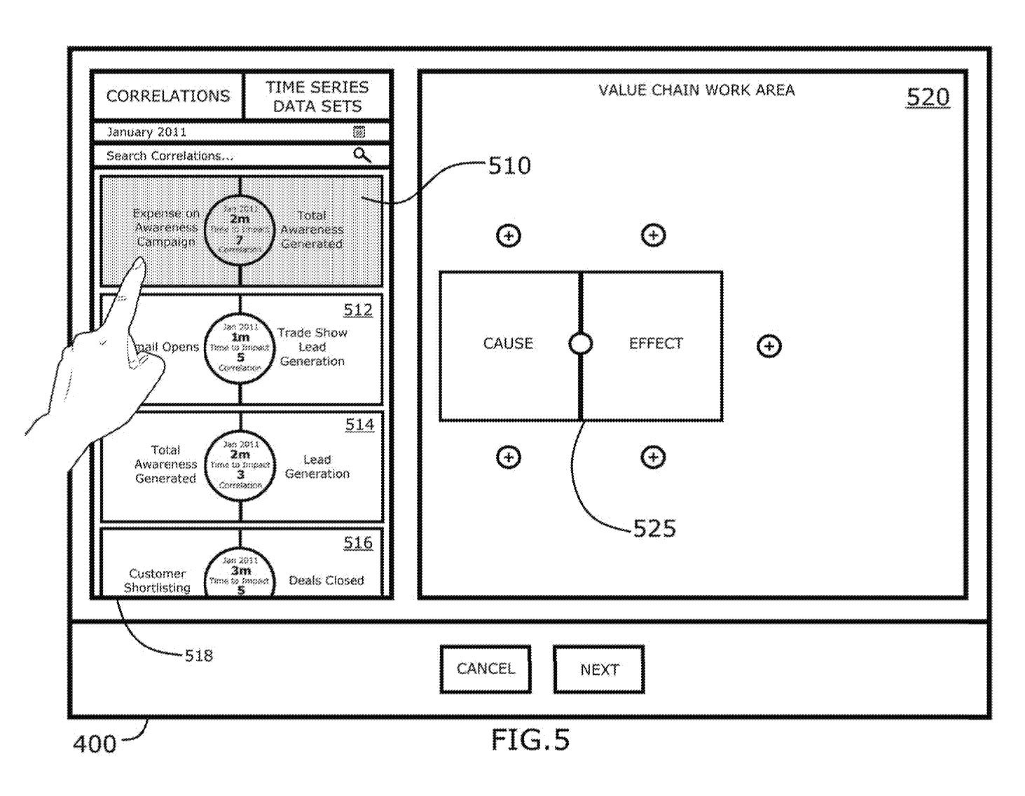

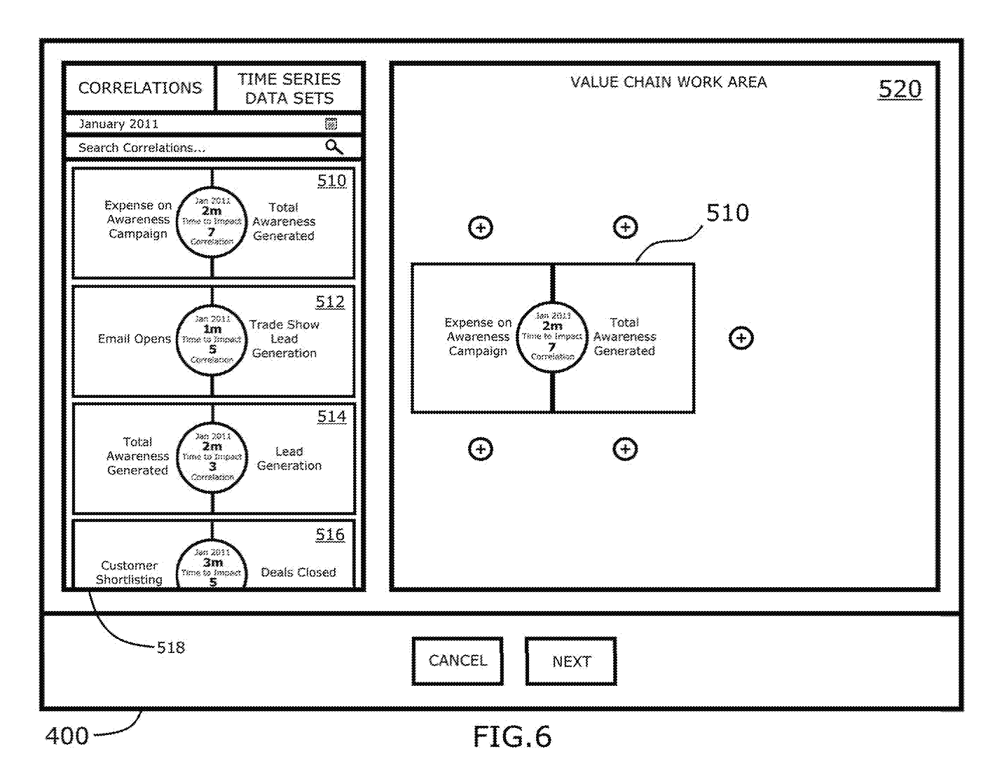

Specifically, FIG. 4 conceptually illustrates a user interface 400 for connecting and visualizing correlated data sets to describe a time-sequenced chain of cause and effect. Turning to FIG. 5, a selection of a first correlated pair graphical element 510 is shown in the user interface 400. Other correlated pair graphical elements 512, 514, and 516 are shown in a correlations/time series data sets column 518. Other correlated pair graphical elements may be included in the correlations/time series data sets column 518, which the user would be able to scroll to view. All such correlated pair graphical elements have been determined to include time series of data that satisfy a threshold correlation level, as determined by comparing the two time series of data (by, for instance, the method for connecting and visualizing correlated data sets to describe a time-sequenced chain of cause and effect 300). Furthermore, the user interface 400 includes a value chain work area 520 and a starting cause/effect icon graphic 525 that indicates a placement of a starting correlated pair graphical element. In this case, the starting correlated pair graphical element is the user-selected first correlated pair graphical element 510. This is shown in FIG. 6, which conceptually illustrates the first correlated pair graphical element 510 added to the value chain work area 520 in the user interface 400, with placement on the cause/effect icon graphic 525.

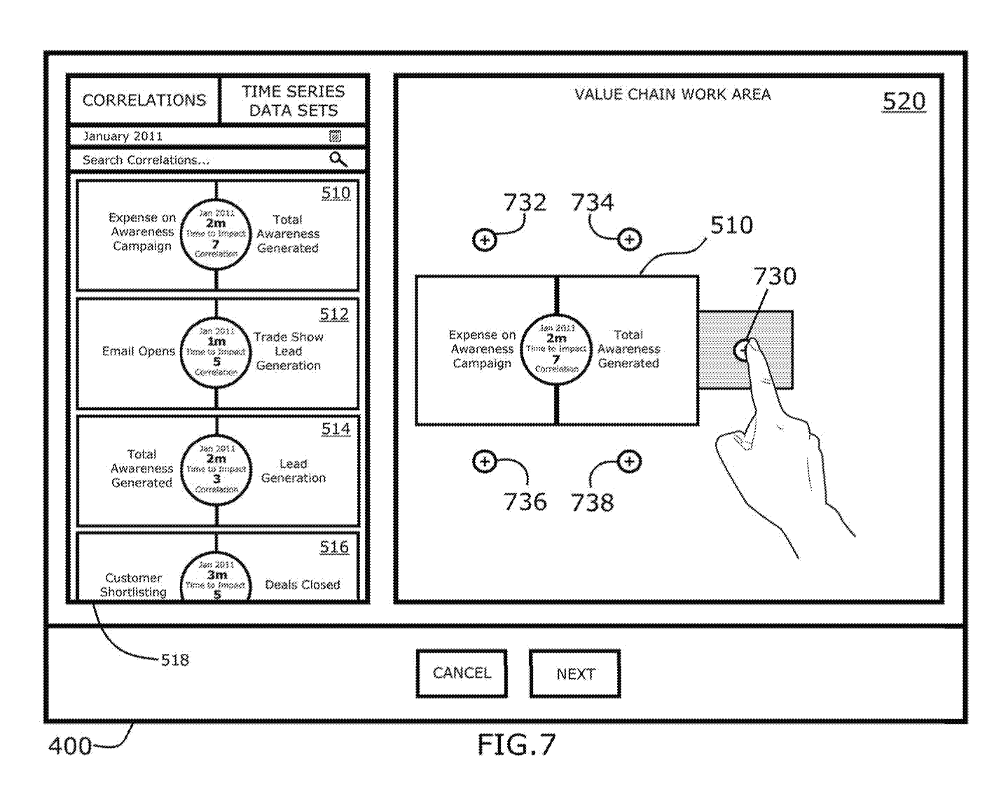

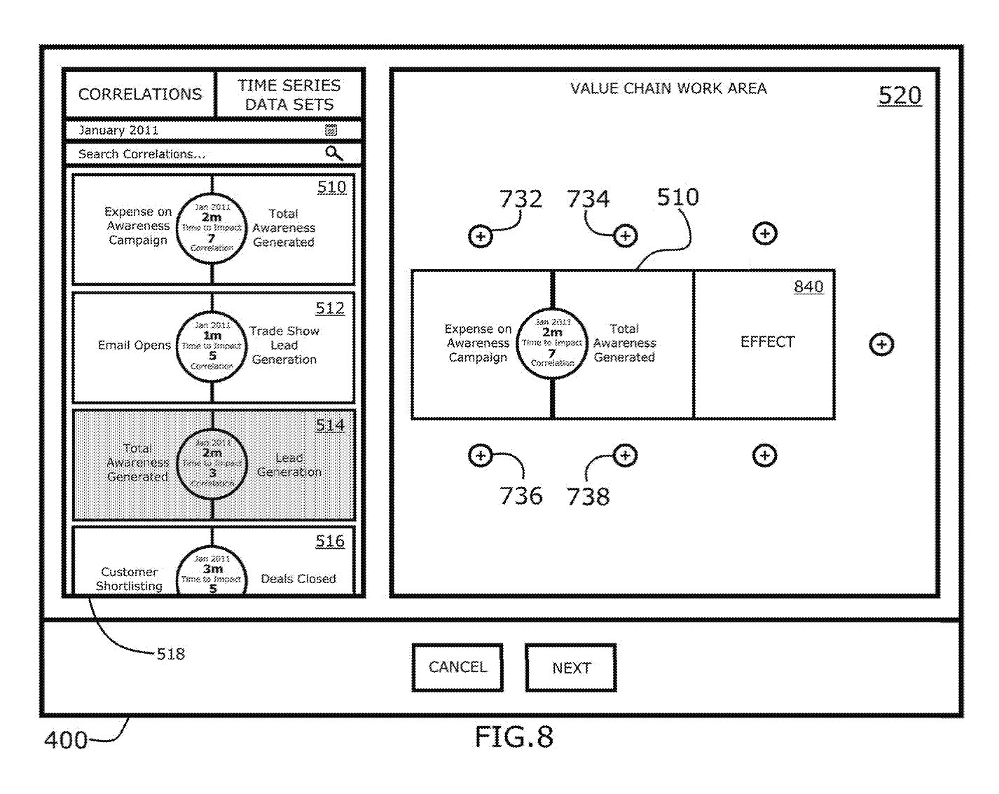

Turning to FIG. 7, which conceptually illustrates a selection of a particular value chain tool 730. As shown, the value chain work area 520 includes several value chain tools 732, 734, 736, and 738 besides the particular value chain tool 730. The placement of the value chain tools is related to an adjacent time series of data from the correlated pair graphical element 510. For instance, value chain tool 730 suggests an “effect” to a “cause”, the cause being “total awareness generated” from the correlated pair graphical element 510. Such an “effect” of “total awareness generated” is represented in the correlations/time series data sets column 518 by some other correlated pair graphical element, namely correlated pair graphical element 514. As shown in correlated pair graphical element 514, “total awareness generated” is the causal element of the correlated pair, with “lead generation” being the effect of “total awareness generated”. The other value chain tools 732, 734, 736, and 738 each relate to an “effect”, if any exists, of the respective adjacent time series of data “causal” element of the first correlated pair graphical element 510. This is shown in FIG. 8, which conceptually illustrates the correlated pair graphical element 514 with a “cause” time series of data that corresponds to the “effect” time series of data of the first correlated pair graphical element 510 added to the value chain work area 520 in the user interface 400. Also, the value chain tool 730 has been replaced in the value chain work area 520 by an effect icon 840, which represents a continuation of the cause-effect relationship that is propagated throughout the value chain that is being created.

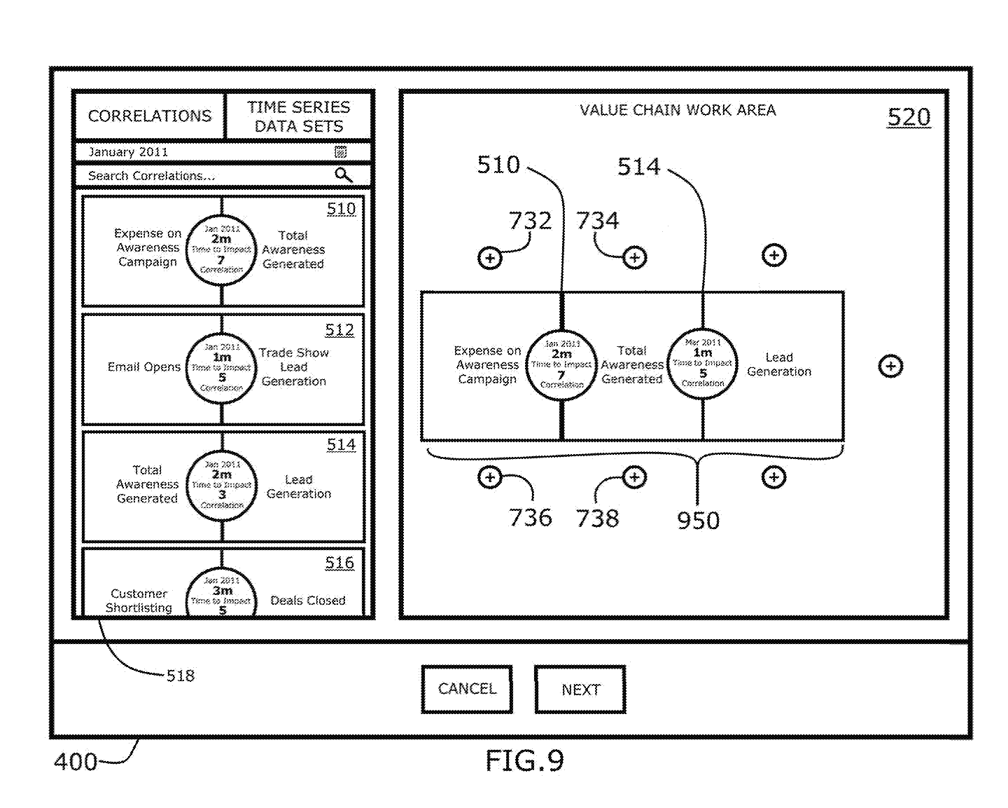

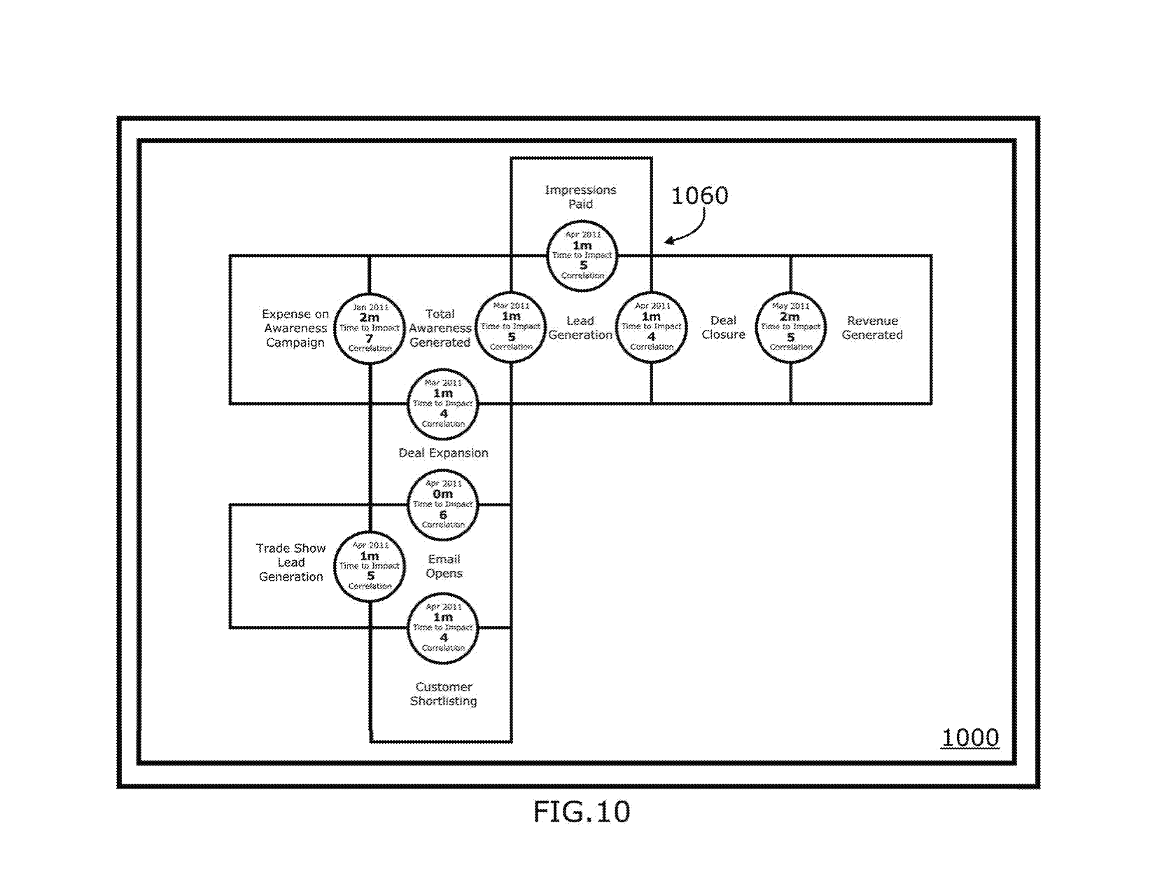

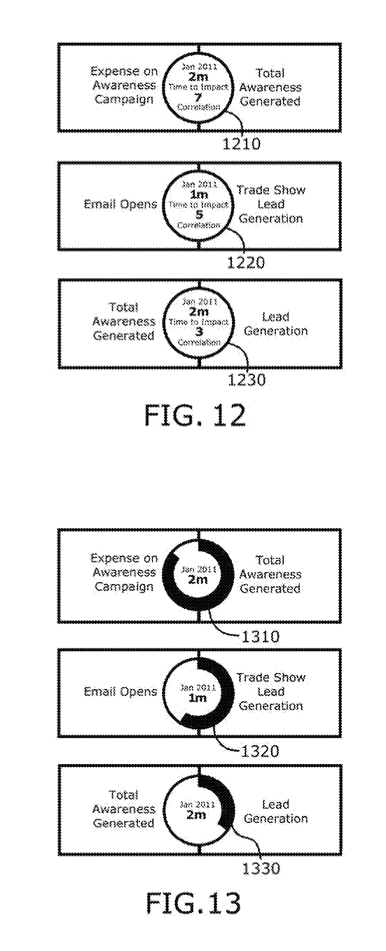

Turning to FIG. 9, which conceptually illustrates the correlated pair graphical element 514 with time-shifted impact data added to a value chain 950 that is starting to take shape in the value chain work area 520 of the user interface 400. After all of the time series of data have been compared to each other, and all of the correlated pair graphical elements have been created and placed in the value chain work area 520, a full value chain may be visually output for the user to view how an initially marketing investment has impact the financial situation of the business, in terms of revenue growth, margin expansion, cash flow, and other such business values. This is shown in FIG. 10, which conceptually illustrates a value chain visual output area 1000 with a full value chain 1060 that includes several correlation pair graphical elements each connected by cause/effect relationship patterns inherent in their respective time series of data. This full value chain 1060 also demonstrates the financial impact of the marketing investment over time, with the full value chain 1060 including time-sequenced connecting correlation pairs. The time-sequencing present in the full value chain 1060 is shown in the strength of correlation indicators between each time series of data in the full value chain 1060. However, other types of strength of correlation indicators could be employed to convey the same information as that shown in this full value chain 1060. Other types of strength of correlation indicators are described in greater detail below, by reference to FIGS. 12 and 13.

While the examples above pertain to connecting and visualizing correlated data sets of time-sequenced marketing investment and business data, a person skilled in the relevant art would appreciate that the method for connecting and visualizing correlated data sets to describe a time-sequenced chain of cause and effect can be used in any of several manners that are not represented in the descriptions and examples above. Thus, software that implements the method can be instantiated and used agnostically for any application or problem, regardless of the size of the data sets or the number of correlations or the duration of the time lapse. For example, it would be possible to adapt the method to provide utility in fire-related deaths as correlated to annual rainfall levels (e.g., level of rainfall in each of 100 cities is measured for a specific year and the number of fires in the city tallied for some future year to demonstrate a relationship between surface moisture and subterranean (or sub-surface moisture) and the number of fires in subsequent years).

Also, the steps of the method can be adapted to provide any graphical visual element as wished by a user. In other words, even though the examples above focus on domino-style GUI elements, a different implementation may include a different set of GUI tools and elements that represent the data correlations.

The details and examples of the last two sections focus on methods for connecting marketing investment to financial impact and for connecting and visualizing correlated data sets to describe a time-sequenced chain of cause and effect. In the next section, an investment impact value chain connection and visualization system is described.

### III. Cloud-Network Investment Impact Value Chain Connection and Visualization System

By way of example, FIG. 11 conceptually illustrates a network architecture of a cloud-network investment impact value chain connection and visualization system 1100 that connects marketing investment over time to financial impact. As shown in this figure, the investment impact value chain connection and visualization system 1100 includes a plurality of client computing devices 1110a-1110n, a value chain connection and visualization server 1120, a private time series data aggregation database 1125, a time series data correlation database 1130, and a cloud-based time series data aggregation database 1135.

The value chain connection and visualization server 1120 of some embodiments is a cloud-based server accessible over the Internet. In some embodiments, the value chain connection and visualization server 1120 provides an application service for businesses, organizations, or other entities to aggregate, track, and correlate marketing investment expense over time and visualize a time-shifted value chain that illustrates financial and business impact of the marketing investment expense over time. In some embodiments, the value chain connection and visualization server 1120 is indirectly connected to the private time series data aggregation database 1125. For example, the private time series data aggregation database 1125 may be a data source of a business associated with at least one of the client computing devices 1110a-1110n which is accessing or has accessed the value chain connection and visualization server 1120. In some such cases, the value chain connection and visualization server 1120 may access the private time series data aggregation database 1125 over a secure and private network connection (e.g., private cloud).

In some embodiments, the value chain connection and visualization server 1120 is directly connected to the cloud-based time series data aggregation database 1135. For example, a business or entity that uses the cloud-network investment impact value chain connection and visualization system 1100 may store all-time series data related to one or more of its marketing campaigns in the cloud-based time series data aggregation database 1135, instead of storing the data in some local storage repository. In some embodiments, the value chain connection and visualization server 1120 stores individual sets of time series data in the cloud-based time series data aggregation database 1135 in an original (or raw data) format without connection or correlation to other sets of time series data.

In some cases, a business or entity that uses the cloud-network investment impact value chain connection and visualization system 1100 may store the time series data related to some of its marketing campaigns in the cloud-based time series data aggregation database 1135 while storing time series data related to other marketing campaigns in the private time series data aggregation database 1125.

In some embodiments, the value chain connection and visualization server 1120 is connected to the time series data correlation database 1130. In some embodiments, the value chain connection and visualization server 1120 retrieves multiple time series data sets from one or both of the private time series data aggregation database 1125 and the cloud-based time series data aggregation database 1135 and then compares the multiple time series data sets to identify any time series data sets which are associated by a cause and effect relationship. In some embodiments, the value chain connection and visualization server 1120 correlates any identified pairs of different time series data sets which are recognized as being associated through a causal relationship (or rather, a cause and effect relationship).

In some embodiments, the value chain connection and visualization server 1120 stores correlated pairs of time series data in the time series data correlation database 1130. The correlated pairs of time series data can then be visually output in a graphical user interface (GUI) of a computer screen or another output display (e.g., a projector) connected to a client computing device 1110a-1110n of a user. By facilitating the visualization and connection of correlated pairs and the creation of a value chain of expense related to a marketing campaign, the user can easily comprehend the direct and indirect value of marketing campaign expense over time and see the overall financial impact of the campaign.

In some embodiments, the value chain connection and visualization server 1120 may retrieve strength of correlation parameters that allow the value chain connection and visualization server 1120 to incorporate visual indicators in the graphical display of the correlated pairs of time series data and/or the value chain.

By way of example, FIG. 12 conceptually illustrates an example of three alphanumeric visual indicators 1210-1230 for the strength of correlation in three correlation pairs. Specifically, alphanumeric visual indicator 1210 indicates a correlation value of 7, alphanumeric visual indicator 1220 indicates a correlation value of 5, and alphanumeric visual indicator 1230 indicates a correlation value of 3.

In another example, FIG. 13 conceptually illustrates an example of three circular bar graph visual indicators 1310-1330 for the strength of correlation in three correlation pairs. Specifically, circular bar graph visual indicator 1310 is a nearly complete circle to signify a higher correlation value (e.g., correlation value of 7), circular bar graph visual indicator 1320 is slightly more than a half circle to signify a correlation value (e.g., correlation value of 5) that is of medium strength, and circular bar graph visual indicator 1330 is less than a half circle to signify a weaker correlation value (e.g., correlation value of 3).

While the visual indicators described by reference to FIGS. 12 and 13 are demonstrative of different styles that may be employed to indicate a strength of correlation for a given correlation pair, a person skilled in the relevant art would appreciate that the types of visual indicators that could be used is without limit. Some examples of visual indicators include, without limitation, alphanumeric textual indicators (e.g., a higher correlation value of 6, a lower correlation value of 2, etc.), colored indicators (e.g., red for high correlation, purple for medium correlation, blue for low correlation, etc.), three dimensional heat mapping of the overall value chain (e.g., the path with most highly correlated set of time series data raised to a peak level with the path having the weakest correlated sets of time series data lowered to a valley, etc.), bar graph indicators, circular bar graph indicators, etc. Furthermore, some embodiments of the investment impact value chain connection and visualization system 1100 illustrate correlation strength as a trend in view of changing correlation strength over time.

Turning back to the cloud-network investment impact value chain connection and visualization system 1100 of FIG. 11, each of the client computing devices 1110a, 1110b, 1110c, and 1110n connects to the value chain connection and visualization server 1120 over a network (labeled “cloud” in this figure), such as the Internet (public), or a private network (or labeled “private cloud” in this figure), to visualize a value chain that connects marketing investment to financial impact on revenue, margin, and/or cash flow and to visualize the financial impact in view of marketing campaign data over time (time-shifting of the data sets).

To make the investment impact value chain connection and visualization system 1100, a software developer may create software that implements the methods described in the first and second sections above. The software may be installed and run on any one of the client computing devices 1110a-1110n and/or the value chain connection and visualization server 1120. The cloud-network investment impact value chain connection and visualization system 1100 may be deployed over a commercial cloud-computing provider. As such, the cloud-network investment impact value chain connection and visualization system 1100 may be built on a software as a service (SaaS) architecture, a platform as a service (PaaS) architecture, an infrastructure as a service (IaaS) architecture, or another cloud-computing architecture that includes one or more features of one or more of these types of cloud-computing architectures and/or customized features of other systems.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. For instance, the system and methods of the present disclosure are adaptable for use in other areas of business because the logic sequences in the steps of the methods are agnostic. Therefore, an individual could apply the same approaches to other data sets in other areas of the business with similar cause-and-effect questions. Thus, one of ordinary skill in the art would understand that the invention is not to be limited by the foregoing illustrative details, but rather is to be defined by the appended claims.

### IV. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

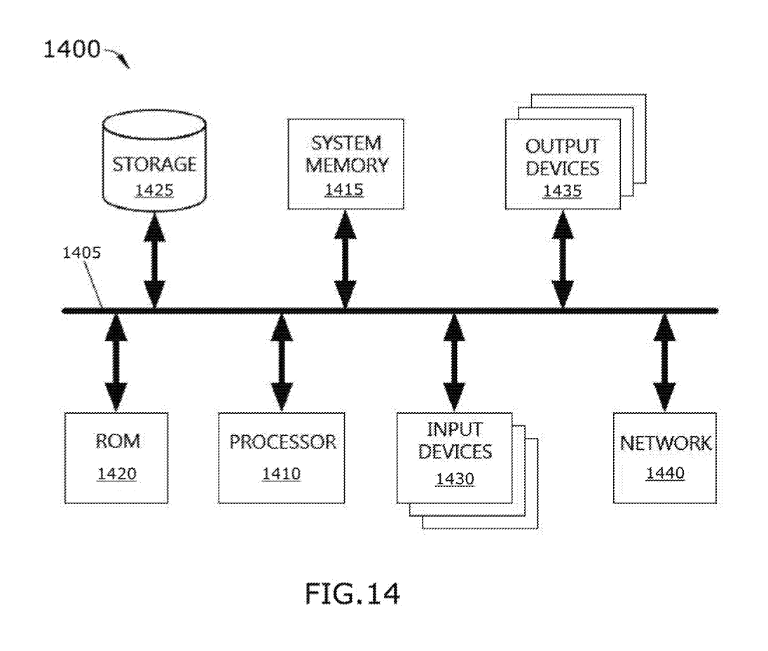

FIG. 14 conceptually illustrates an electronic system 1400 with which some embodiments of the invention are implemented. The electronic system 1400 may be a computer, phone, PDA, tablet, or any other sort of electronic device. Such an electronic system includes various types of computer readable media and interfaces for various other types of computer readable media. Electronic system 1400 includes a bus 1405, processing unit(s) 1410, a system memory 1415, a read-only 1420, a permanent storage device 1425, input devices 1430, output devices 1435, and a network 1440.

The bus 1405 collectively represents all system, peripheral, and chipset buses that communicatively connect the numerous internal devices of the electronic system 1400. For instance, the bus 1405 communicatively connects the processing unit(s) 1410 with the read-only 1420, the system memory 1415, and the permanent storage device 1425.

From these various memory units, the processing unit(s) 1410 retrieves instructions to execute and data to process in order to execute the processes of the invention. The processing unit(s) may be a single processor or a multi-core processor in different embodiments.

The read-only-memory (ROM) 1420 stores static data and instructions that are needed by the processing unit(s) 1410 and other modules of the electronic system. The permanent storage device 1425, on the other hand, is a read-and-write memory device. This device is a non-volatile memory unit that stores instructions and data even when the electronic system 1400 is off. Some embodiments of the invention use a mass-storage device (such as a magnetic or optical disk and its corresponding disk drive) as the permanent storage device 1425.

Other embodiments use a removable storage device (such as a floppy disk or a flash drive) as the permanent storage device 1425. Like the permanent storage device 1425, the system memory 1415 is a read-and-write memory device. However, unlike storage device 1425, the system memory 1415 is a volatile read-and-write memory, such as a random access memory. The system memory 1415 stores some of the instructions and data that the processor needs at runtime. In some embodiments, the invention's processes are stored in the system memory 1415, the permanent storage device 1425, and/or the read-only 1420. For example, the various memory units include instructions for processing appearance alterations of displayable characters in accordance with some embodiments. From these various memory units, the processing unit(s) 1410 retrieves instructions to execute and data to process in order to execute the processes of some embodiments.

The bus 1405 also connects to the input and output devices 1430 and 1435. The input devices enable the user to communicate information and select commands to the electronic system. The input devices 1430 include alphanumeric keyboards and pointing devices (also called “cursor control devices”). The output devices 1435 display images generated by the electronic system 1400. The output devices 1435 include printers and display devices, such as cathode ray tubes (CRT) or liquid crystal displays (LCD). Some embodiments include devices such as a touchscreen that functions as both input and output devices.

Finally, as shown in FIG. 14, bus 1405 also couples electronic system 1400 to a network 1440 through a network adapter (not shown). In this manner, the computer can be a part of a network of computers (such as a local area network (“LAN”), a wide area network (“WAN”), or an intranet), or a network of networks (such as the Internet). Any or all components of electronic system 1400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-3 conceptually illustrate methods in which the specific operations of each method may not be performed in the exact order shown and described. Specific operations may not be performed in one continuous series of operations, and different specific operations may be performed in different embodiments. Furthermore, each method could be implemented using several sub-methods, or as part of a larger macro method. Thus, one of ordinary skill in the art would understand that the invention is not to be limited by the foregoing illustrative details, but rather is to be defined by the appended claims.

I claim:

1. A method for connecting marketing investment to impact on business revenue, margin, and cash flow, said method comprising:
establishing a marketing expense amount;
retrieving a set of marketing campaign performance data;
correlating the retrieved set of marketing campaign performance data to the established marketing expense amount;
retrieving a set of audience belief assessment data;
correlating the retrieved set of audience belief assessment data to the established marketing expense amount;
retrieving a set of audience behavior assessment data;
correlating the retrieved set of audience behavior assessment data to the established marketing expense amount;
retrieving a set of financial impact assessment data;
correlating the retrieved set of financial impact assessment data to the established marketing expense amount; and
correlating the set of marketing campaign performance data, the set of audience belief assessment data, the set of audience behavior assessment data, and the set of financial impact assessment data to impact on business revenue, margin, and cash flow.
